(19) United States
(12) Patent Application Publication
(10) Pub. No.: US 2005/0212326 A1
(43) Pub. Date: Sep. 29, 2005

(54) Structural reinforcement member and system formed therewith

(75) Inventor: Thomas Marion, Oxford, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/157,347

(22) Filed: Jun. 21, 2005

Related U.S. Application Data
(60) Provisional application No. 60/582,587, filed on Jun. 24, 2004.

(51) Int. Cl. B62D 25/00

(52) U.S. Cl. 296/187.03

(57) ABSTRACT

There is disclosed a reinforcement member, a system formed with the reinforcement member and a method of using the reinforcement. The reinforcement member typically includes a plurality of walls with one wall being movable (e.g., rotatable) relative to another walls. The reinforcement member is typically suitable for insertion into a cavity of a structure.

### CLAIM OF PRIORITY

To the extent applicable, the present invention claims the benefit of the priority of U.S. Provisional Application Ser. No. 60/582,587, filed Jun. 24, 2004, the contents of which are incorporated by reference herein.

### FIELD OF THE INVENTION

The present invention relates generally to a reinforcement member for use in strengthening, stiffening or stabilizing different portions of an automotive vehicle or other article of manufacture and a structural system formed therewith.

### BACKGROUND OF THE INVENTION

For many years industry, and particularly the transportation industry, has been concerned with designing reinforcement members or assemblies that have desirable characteristics such as low weight, high strength, low cost, versatility, combinations thereof or the like. As examples, U.S. Pat. Nos. 5,755,486; 4,901,500; and 4,751,249 describe prior art reinforcing devices. In the interest of continuing such innovation, the present invention provides a reinforcement member having one or more desirable characteristics. The present invention also provides a system that can be formed with the reinforcement member and a method of using the member.

### SUMMARY OF THE INVENTION

A structural reinforcement system is disclosed. The system includes a structure of an article of manufacture (e.g., an automotive vehicle). Typically, the structure has a plurality of walls at least partially defining a cavity. The system also includes a reinforcement member that can located within the cavity of the structure. The reinforcement member includes a first wall and a second wall pivotally attached to the first wall. The reinforcement member also includes an expandable material, which may be located at least partially between the first wall and the second wall. Upon exposure to heat or other condition, the expandable material foams and expands and causes at least one of the first wall and the second wall to rotate relative to the other of the first wall and the second wall.

### BRIEF DESCRIPTION OF THE DRAWINGS

The features and inventive aspects of the present invention will become more apparent upon reading the following detailed description, claims, and drawings, of which the following is a brief description:

FIG. 1 is a top view of an exemplary reinforcement member in accordance with an aspect of the present invention.

FIG. 2 is another top view of the exemplary reinforcement member of FIG. 1.

FIG. 3 is a top view of an exemplary reinforcement system employing the exemplary reinforcement member of FIGS. 1 and 2 in accordance with an aspect of the present invention.

FIG. 4 is a top view of the exemplary reinforcement system of FIG. 3 at a later processing stage.

### DETAILED DESCRIPTION OF THE PREFERRED EMBODIMENT

The present invention is predicated upon a reinforcement member, a system formed with the reinforcement member and a method of using the reinforcement member. Typically, the reinforcement member includes a plurality (e.g., 2, 3, 4 or more) of walls. At least one of the plurality of walls (e.g., a first wall) is typically movable (e.g., pivotable or rotatable) relative to another of the plurality of walls (e.g., a second wall). The reinforcement member also includes one or more masses of expandable material. Typically, at least one mass of expandable material is located at least partially between the first wall and the second wall and, upon expansion, the expandable material causes movement (e.g., rotation) of at least one of the first and second walls relative to the other. While the reinforcement member is primarily described below as being applied to (e.g., placed within a cavity of) an automotive vehicle, it is contemplated that the reinforcement member may be applied to a variety of other articles of manufacture such as buildings, furniture, airplanes, boats, trains or the like.

FIGS. 1-4 illustrate an example of a reinforcement member 10 configured for placement within a cavity 12 of an automotive vehicle (not shown) for forming a reinforced structural system 14 along with at least one structure 16 of the vehicle. Typically, the structure 16 of the vehicle at least partially defines the cavity 12. As will be appreciated, the reinforcement member 10 may be suited for placement in a variety of cavities for reinforcing a variety of structures of the automotive vehicle. Thus, the reinforcement member may be used for reinforcing structures such as frame structures, body structures, roof assemblies, bumpers, closure devices (e.g., doors, decklids) or the like. For purposes of illustration, without limitation, the structure 16 is illustrated a pillar (e.g., an A-pillar, a B-pillar, a C-pillar or a D-pillar) of an automotive vehicle.

In the particular embodiment illustrated, the reinforcement member 10 includes a carrier 18 that is comprised of a first or base wall 20, a second wall 22 and a third wall 24. As shown, the walls 20, 22, 24 are generally rectangular, each having a first or inner surface 30 opposing a second or outer surface 32 with a thickness therebetween. It is contemplated, however, that the wall may be shaped as need or desired. As examples, the walls may be contoured, cylindrical, planar, combinations thereof or the like. Moreover, it is contemplated that the member may have fewer or greater than three walls.

The reinforcement member 10 typically includes one or more (e.g., 2, 3, 4 or more) masses of expandable material and one or more (e.g., 2, 3, 4 or more) masses of reinforcement material disposed thereon. In the embodiment illustrated, a mass 36 of expandable material is disposed upon the first surface 30 of the first wall 20 and three masses 40, 42 and 44 are respectively disposed upon the second surfaces 32 of each of the three walls 20, 22, 24.

The carrier, the walls or both may be formed from a variety of different materials including, but not limited to, metal, plastic, polymeric material, fiberglass, wood, fabrics, paper products, molding compound (e.g., sheet, bulk or thick molding compound) or the like. Preferably, the walls 20, 22, 24 are rigid or semi-rigid although not required. In one embodiment, the walls 20, 22, 24 are formed of injection molded nylon, injection molded polymer, or molded metal (such as aluminum, magnesium, steel and titanium, an alloy derived from the metals, and even a metallic foam).

The expandable material and the reinforcement material may be formed from a variety of suitable materials and the expandable material may be the same, similar to or different from the reinforcement material. Preferably, the expandable material and the reinforcement material are formed of heat activated materials having foamable characteristics, although not required. The materials may be generally dry to the touch or tacky and may be shaped in any form of desired pattern, placement, or thickness, but are preferably of substantially uniform thickness.

Though other heat-activated materials are possible for the expandable material, the reinforcement material or both, a preferred heat activated material is an expandable polymer or plastic, and preferably one that is foamable. A particularly preferred material is a foam having a polymeric formulation that includes one or more of an acrylate, an acetate, an epoxy resin, an elastomer, a combination thereof or the like. For example, and without limitation, the foam may be an EVA/rubber based material, including an ethylene copolymer or terpolymer that may possess an alpha-olefin. As a copolymer or terpolymer, the polymer may be composed of two or three different monomers, i.e., small molecules with high chemical reactivity that are capable of linking up with similar molecules. Examples of suitable materials for either the expandable or reinforcement material are disclosed in U.S. patent application Ser. No. 60/482,897, filed Jun. 26, 2003, titled Exandable Material, which is incorporated herein by reference for all purposes.

A number of baffling, reinforcing or sealing foams are known in the art and may also be used to produce foam from the expandable material or the reinforcement material. A typical foam includes a polymeric base material, such as one or more ethylene-based polymers which, when compounded with appropriate ingredients (typically a blowing and curing agent), expand and cure in a reliable and predictable manner upon the application of heat or the occurrence of a particular ambient condition. From a chemical standpoint for a thermally-activated material, the structural or baffling foam is usually initially processed as a flowable material before curing, and upon curing, the material will typically cross-link making the material incapable of further flow.

One advantage of the preferred foam materials over prior art materials is that the preferred materials for the expandable or reinforcement material can be processed in several ways. The preferred materials can be processed by injection molding, extrusion compression molding or with a mini-applicator. This enables the formation and creation of part designs that exceed the capability of most prior art materials.

While the preferred materials for fabricating the expandable material and the reinforcement material have been disclosed, the expandable material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. See also, U.S. Pat. Nos. 5,766,719; 5,755,486; 5,575,526; and 5,932,680, (incorporated by reference). In general, the desired characteristics of the material include high glass transition temperature (typically greater than 70 degrees Celsius) and adhesion durability properties. In this manner, the material does not generally interfere with the materials systems employed by automobile manufacturers.

In applications where the expandable material and/or the reinforcement mateiral is a heat activated, thermally expanding material, an important consideration involved with the selection and formulation of the material comprising the foam is the temperature at which a material reaction or expansion, and possibly curing, will take place. Typically, the foam becomes reactive at higher processing temperatures, such as those encountered in an automobile assembly plant, when the foam is processed along with the automobile components at elevated temperatures or at higher applied energy levels, e.g., during paint or e-coat curing or processing steps. While temperatures encountered in an automobile assembly operation may be in the range of about 148.89° C. to 204.44° C. (about 300° F. to 400° F.), body and paint shop applications are commonly about 93.33° C. (about 200° F.) or slightly higher. If needed, blowing agent activators can be incorporated into the composition to cause expansion at different temperatures outside the above ranges. Generally, suitable expandable foams have a range of expansion ranging from approximately 0 to 1000 percent or greater.

In another embodiment, the expandable material and/or the reinforcement are provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

It is contemplated that the expandable material and/or the reinforcement material could be delivered and placed into contact with the carrier, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

Although, as stated, the expandable material and the reinforcement material may be the same, they are typically different. The expandable material is typically configured to expand more than the reinforcement material relative to their respective original sizes. The expandable material is typically configured to volumetrically expand to a volume that is at least 300% or less, more typically at least 450% and even more typically at least 700% of its original unexpanded volume. The reinforcement material is typically configured to volumetrically expand to a volume that is greater than 105% but less than about 600% or more, more typically less than about 400% and even more typically less than about 290% of its original unexpanded volume. Additionally, the density of the reinforcement material, after expansion, typically tends to be greater than the density of the expandable material.

Formation

Formation of the reinforcement member 10 may be accomplished using a variety of techniques and protocols. Generally, the plurality of walls are connected to each other and, before, after or during such connecting, the expandable material and reinforcement material are disposed upon the walls of the member. It should be understood that the expandable material and the reinforcement material may be disposed directly upon the walls or may be disposed upon another substrate, which is connected to or disposed upon the walls.

Typically, a first wall of the member is movably (e.g., pivotally or rotatably) connected to a second wall of the member and the expandable material is positioned relative to the first and second walls such that, upon expansion, the expandable material urges the second wall to move (e.g., rotate or pivot) away from the first wall, vice versa or both. In such an embodiment, the expandable material is typically located at least partially or substantially entirely between the first and second walls.

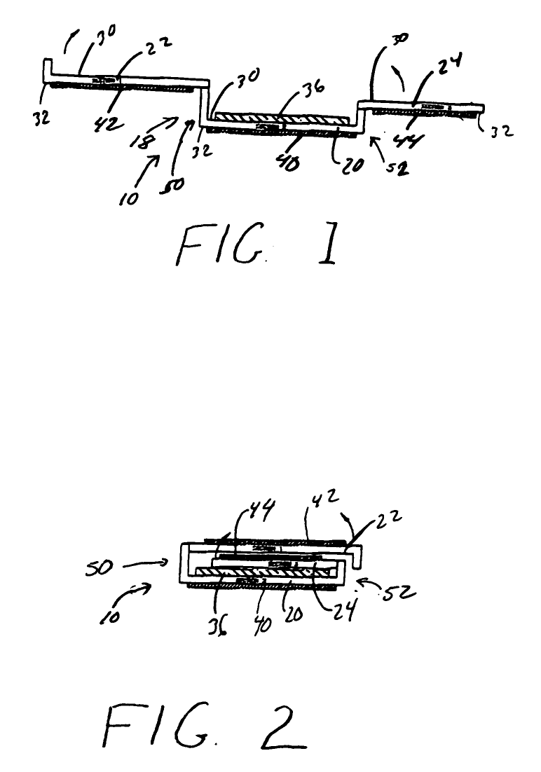

In the particular embodiment illustrated, the second wall 22 and the third wall 24 are respectively rotatably connected to a first side 50 and a second side 52 of the first wall 20, the first side 50 being opposite the second side 52. As shown in FIGS. 1 and 2, the second and third walls 22, 24, prior to expansion of the expandable material, are rotated to oppose and overlay the first wall 20 such that the mass 36 of expandable material is located between the first wall 20 and second wall 22 and between the first wall 20 and third wall 24.

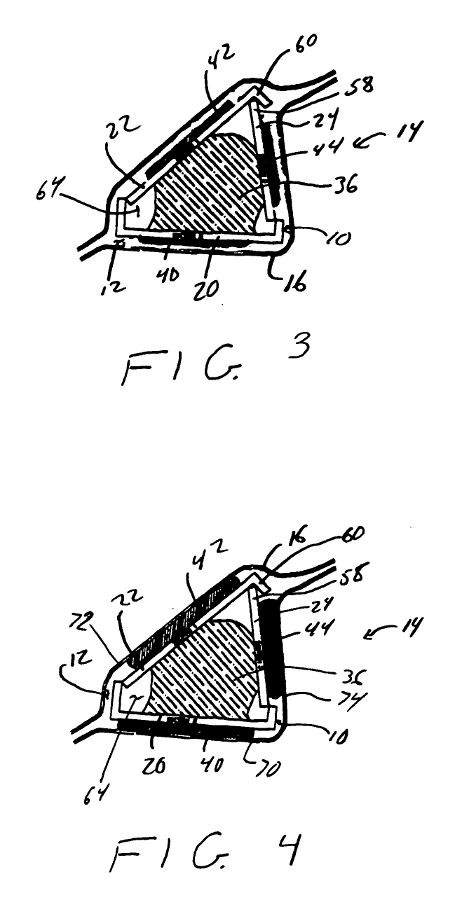

Upon activation, and referring to FIGS. 3 and 4 the mass 36 of expandable material expands from its location between the walls 20, 22, 24 and moves (e.g., rotates) the second wall 22 and the third wall 24 away from the first wall 20. For rotation in the embodiment illustrated, the mass 36 of expandable material contacts and urges the third wall 24 into the second wall 22 causing both walls 22, 24 to rotate away from the first wall 20. Such rotation is halted when a side 58 of the third wall 24 abuts an extension 60 of the second wall 22. In turn, after expansion, the reinforcement member 10 has a generally triangular cross-sectional configuration with an internal cavity 64 and the expanded mass 36 of material located within the cavity 64 and the masses 40, 42, 44 of reinforcement material are located on the second surfaces 32 of the walls 20, 22, 24 external of the cavity 64. As shown, the extension 60 is located at one side of second wall 22, but may be located anywhere along that wall 22 depending on the desired degree of rotation.

Installation

Typically, the reinforcement member is placed within a cavity of a structure of an automotive vehicle. The reinforcement member may be placed with the cavity of the structure before or after activation and expansion of the expandable material. Thus, in the embodiment shown, the member 10 may be placed within the cavity 12 of the structure 16 in its condition shown in FIG. 2 (i.e., prior to expansion of the mass 36 of expandable material and prior to activation and/or expansion of the masses 40, 42, 44 of reinforcement material) or in the condition shown in FIG. 3 (i.e., after expansion of the mass 36 of expandable material but prior to activation and/or expansion of the masses 40, 42, 44 of reinforcement material).

After insertion into the cavity of the structure, the masses of reinforcement material are typically activated to expand to, wet, cure, adhere to or a combination thereof the walls of the structure thereby forming a reinforced structure or system.

In FIG. 3, the member 10 has been placed in the cavity 12 of the structure 16 and the structure 16 is shown as an automotive pillar. As shown, the mass 36 of expandable material has already been activated and expanded. Upon exposure to heat (e.g., from an e-coat or painting oven or otherwise as described), the masses 40, 42, 44 of reinforcement material expand to contact, wet and, upon curing, adhere to walls 70, 72, 74 of the structure 16 that define the cavity 12 thereby forming the reinforced structure or system 14 of FIG. 4. Of course, if the mass 36 of expandable material is not pre-expanded, it is possible for the same heat (e.g., from an e-coat or painting oven or otherwise as described) to activate both the mass 36 of expandable material and the masses 40, 42, 44 of reinforcement material simultaneously, successively or a combination thereof to form the structure or system 14 of FIG. 4.

In additional or alternative embodiments, it is contemplated that the member of the present invention may additionally or alternatively used as a baffling member. In such an embodiment, it is preferable for the expandable material and the reinforcement material to expand to a sufficient degree to substantially seal the cavity of the structure against passage of materials therethrough and/or to divide the cavity of the structure into two or more areas. Moreover, in such an embodiment, the reinforcement material may be replace with a baffling material as described herein.

In another alternative embodiment, it is contemplated that the reinforcement member of the present invention may be used to form a modular reinforcement assembly. In such an embodiment, a plurality (e.g., 2, 3, 4, 5, or more) of reinforcement members like the member 10 of FIGS. 1-4 may be movably connected to each other as a chain or may be separate. In such an embodiment, the chain of members or separate members could be inserted into a cavity of a structure and the expandable material and reinforcement material of each of the members could be activated as described above. In such an embodiment the multiple members may be stacked individually onto each other with the cavity of the structure or the multiple reinforcement members may be connected to each other using a variety of connection devices, which may allow pivoting motion, accordion motion or other types of motion of the members relative to each other as the members are inserted into the cavity. Exemplary, types of connections include heal/toe connections, ball and socket connections or others. Additional disclosure of modular type reinforcement assemblies can be found in U.S. patent application Ser. No. 10/236,315, filed Sep. 06, 2002, titled Structural Reinforcement System Having Modular Segmented Characteristics, which is incorporated herein by reference for all purposes.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A structural reinforcement system, comprising:
a structure of an automotive vehicle, the structure having a plurality of walls at least partially defining a cavity;
a reinforcement member located within the cavity, the reinforcement member including:
i. a first wall;
ii. a second wall pivotally attached to the first wall; and
iii. an expandable material located at least partially between the first wall and the second wall;
wherein, upon exposure to heat, the expandable material foams and expands and causes at least one of the first wall and the second wall to rotate relative to the other of the first wall and the second wall.

2. A system as in claim 1 further comprising a reinforcement material configured to assist the reinforcement member in adhering to the plurality of walls that at least partially define the cavity.

3. A system as in claim 2 wherein a mass of the reinforcement material is disposed upon each of the first and second walls.

4. A system as in claim 3 wherein the reinforcement material is also expandable but the expandable material is configured to expand more than the reinforcement material.

5. A system as in claim 1 further comprising a third member pivotally attached to at least one of the first member and second member, the third member rotating relative to the first or second member upon expansion of the expandable material.

6. A system as in claim 1 wherein the first wall and second wall are elongated walls.

7. A system as in claim 1 further comprising a secondary reinforcement member attached to the first reinforcement member, the second reinforcement member also including a first wall pivotally attached to a second wall and an expandable material.

8. A structural reinforcement system, comprising:
a structure of an automotive vehicle, the structure having a plurality of walls at least partially defining a cavity;
a reinforcement member located within the cavity, the reinforcement member including:
i. a first wall having a first surface opposite a second surface;
ii. a second wall pivotally attached to the first wall, the second wall having a first surface opposite a second surface; and
iii. an expandable material connected to the first wall;
wherein, upon exposure to heat, the expandable material foams and expands and contacts the first surface of the first wall and the first surface of the second wall thereby causing at least one of the first wall and the second wall to rotate relative to the other of the first wall and the second wall.

9. A system as in claim 8 further comprising a reinforcement material configured to assist the reinforcement member in adhering to the plurality of walls that at least partially define the cavity.

10. A system as in claim 9 wherein a mass of the reinforcement material is disposed upon each of the first and second walls.

11. A system as in claim 10 wherein the reinforcement material is also expandable but the expandable material is configured to expand more than the reinforcement material.

12. A system as in claim 8 further comprising a third member pivotally attached to at least one of the first member and second member, the third member rotating relative to the first or second member upon expansion of the expandable material.

13. A system as in claim 8 wherein the first wall and second wall are elongated walls.

14. A system as in claim 8 further comprising a secondary reinforcement member attached to the first reinforcement member, the second reinforcement member also including a first wall pivotally attached to a second wall and an expandable material.

15. A structural reinforcement system, comprising:
a structure of an automotive vehicle, the structure having a plurality of walls at least partially defining a cavity;
a reinforcement member located within the cavity, the reinforcement member including:
i. a first wall having a first surface and a second surface;
ii. a second wall pivotally attached to the first wall, the second wall having a first surface and a second surface;
iii. a third wall pivotally attached to the first wall; and
iv. an expandable material disposed upon the first surface of the first wall;
wherein, upon exposure to heat, the expandable material foams and expands and causes the second wall and third wall to rotate relative to the first wall until the third wall abuts an extension of the second wall.

16. A system as in claim 15 further comprising a reinforcement material configured to assist the reinforcement member in adhering to the plurality of walls that at least partially define the cavity.

17. A system as in claim 16 wherein a mass of the reinforcement material is disposed upon each of the first, second and third walls.

18. A system as in claim 17 wherein the reinforcement material is also expandable but the expandable material is configured to expand more than the reinforcement material.

19. A system as in claim 8 wherein the first wall and second wall are elongated walls.

20. A system as in claim 8 further comprising a secondary reinforcement member attached to the original reinforcement member, the second reinforcement member also including a first wall pivotally attached to a second wall and an expandable material.
